(19) United States
(12) Patent Application Publication
(10) Pub. No.: US 2010/0136454 A1
(43) Pub. Date: Jun. 3, 2010

(54) FUEL CIRCUIT OF A FUEL CELL SYSTEM

(76) Inventors: Hans-Joerg Heidrich, Ulm (DE); Cosimo S. Mazzotta, Ulm (DE)

Correspondence Address: CROWELL & MORING LLP;INTELLECTUAL PROPERTY GROUP, P.O. BOX 14300, WASHINGTON, DC, 20044-4300, US

(21) Appl. No.: 12/444,810

(22) PCT Filed: Oct. 11, 2006
(86) PCT No.: PCT/EP2006/009798

§ 371 Date: Jan. 28, 2010

(51) Int. Cl. H01M 8/04; H01M 2/00

(52) U.S. Cl. 429/443; 429/513

(57) ABSTRACT

A fuel cell circuit of a fuel cell system includes a fuel cell unit having an input on the anode side for feeding fuel from a storage tank to the fuel cell unit, and an output on the anode side for discharging fuel cell waste gas on the anode side from the fuel cell unit. A recirculation circuit is provided, to return the fuel cell waste gas on the anode side to the input on the anode side. The recirculation circuit is connected to an intake line of an ejector unit, and fuel can be fed from the storage tank directly into the recirculation circuit.

This application is a national stage of International Application No. PCT/EP/2006/009798, filed Oct. 11, 2006, the entire disclosure of which is herein expressly incorporated by reference.

### BACKGROUND AND SUMMARY OF INVENTION

The invention relates to a fuel circuit of a fuel cell system, having a recirculation circuit that returns waste gas from the anode output of the fuel cell to the anode input.

Fuel cell systems conventionally comprise at least one fuel cell unit (also called fuel cell stack), which consists of several individual fuel cells, each of which has an anode, a cathode and a membrane arranged therebetween (for example, an ion-conducting membrane of a polymer electrolyte membrane (PEM)). The individual fuel cells are respectively arranged between two bipolar plates, and their anode sides have flow fields for a preferably gaseous fuel, which is fed to the fuel cells, while the cathode sides have fields for a gaseous oxidant (preferably air), which is fed to the fuel cells. The fuel and the oxidant react at a catalyst material in the interior of the fuel cells to generate electrical energy, with simultaneous generation of water.

So-called PEM fuel cells must be driven by hydrogen which has a certain humidity, so as to achieve a high efficiency factor, to keep the fuel cell membranes humid and to avoid damages which can occur with membranes that are not humidified sufficiently. The product water generated during the fuel cell reaction is for example captured in a water precipitator and can be used to humidify the reaction partners fed to the fuel cells.

It is known that, during feeding of the fuel cell unit with pure hydrogen, with return of the hydrogen the proportion of nitrogen and water increases gradually in the anode circuit, which leads to a deterioration of the efficiency factor. This is prevented by either continually discharging a part of the flowing gases or intermittently opening a discharge valve, so as to reduce the part of nitrogen from time to time. Such procedure increases again the hydrogen concentration in the flow circuit on the anode side by addition of fresh hydrogen, and keeps the efficiency factor on a high level. This rinsing operation (“Purge”) increases the performance of the fuel cell unit considerably.

German patent document DE 102 51 878 A1 discloses a fuel cell system with a fuel circuit which is fed from a hydrogen tank, with unused hydrogen of the fuel cell reaction being recycled with an ejector. The ejector, which is driven by a hydrogen stream from the hydrogen tank, aspires the unused hydrogen from the recirculation line and feeds it with the fresh hydrogen from the tank to the fuel cell. It is suggested that fresh hydrogen from the hydrogen tank can bypass the ejector and is admixed between the ejector and the fuel cell input of the anode feed. In this manner, unfavorable changes in the circulation flow rate can be prevented in certain operating states of the fuel cell system, possibly with acceleration phases.

One object of the invention is to provide a fuel circuit of a fuel cell system, in which a circulation flow rate can be decoupled from an operating state of the fuel cell unit.

This and other objects and advantages are achieved by the fuel circuit of a fuel cell system according to the invention, which includes a fuel cell unit with an input on the anode side for feeding fuel from a storage tank to the fuel cell unit, and an output on the anode side for discharging fuel cell waste gas on the anode side from the fuel cell unit. A recirculation circuit in provided to return the fuel cell waste gas from the anode side of the fuel cell unit to the input on the anode side. The recirculation circuit is connected to an intake line of an ejector unit, and fuel from the storage tank can be fed directly to the recirculation circuit; that is, the fuel cell waste gas on the anode side. In this manner, fresh hydrogen can always be fed to the recirculation circuit. The fuel is preferably hydrogen.

A water precipitator, and subsequently a conveyor unit, can be arranged in the recirculation circuit in the flow direction of the fuel cell waste gas. The conveyor unit can preferably be a fan for hydrogen. Other conveyor devices are also conceivable, for instance an ejector or the like.

It is particularly advantageous if an input point for fuel from the storage tank is provided between the conveyor unit and the ejector unit.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an arrangement of a preferred fuel circuit, with a feed of hydrogen to a waste gas flow upstream of an ejector; and

FIG. 2 shows further arrangements of a preferred fuel circuit, with a feed of hydrogen to a waste gas flow in or upstream of a hydrogen fan.

### DETAILED DESCRIPTION OF THE DRAWINGS

Functionally similar elements in the figures are designated with the same reference numerals.

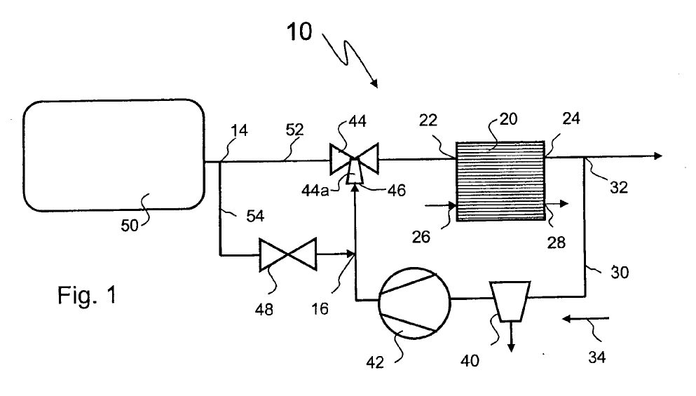

For the explanation of the invention, FIG. 1 schematically shows a section of a fuel cell system 10 with a fuel cell unit having an input 22 on the anode side for feeding fuel from a storage tank 50 to the fuel cell unit, and an output 24 on the anode side for discharging fuel cell waste gas on the anode side from the fuel cell unit 20. The fuel reaches the input 22 on the anode side of the fuel cell unit 20 by means of a feed line 52, in which is arranged a valve 44.

The fuel is preferably hydrogen, and the storage tank 50 is a pressure tank. The fuel cell unit 20 is preferably constructed of individual fuel cells with polymer electrolyte membrane. The construction of these fuel cell units 20 is

An input point for fuel from the storage tank can additionally or alternatively be provided upstream of the hydrogen conveyor unit or upstream of the water precipitator.

An additional input point for fuel from the storage tank can also be present between the ejector unit and the anode input.

An input point for fuel from the storage tank can also be provided, either in addition or alternatively, at the conveyor unit in such a manner that the fuel can be used to support the drive of the conveyor unit. If the conveyor unit is formed as a fan, the input point can be positioned in such a manner that incoming hydrogen effects an additional pulse to the rotor of the fan. The conveyor unit can advantageously be formed as a fan and the input point can be provided at a bearing location of the conveyor unit, or also at other locations which are susceptible to humidity or water and ice formation. A condensation of water in the fan can be avoided or at least be reduced significantly.

In a preferred embodiment, the ejector unit can be integrated in a control valve for controlling the fuel feed to the fuel cell unit. Fuel from the storage tank (preferably a high pressure tank for hydrogen) can be expanded with the control valve, and mixed with the medium from the recirculation circuit. A jet pump-like arrangement of the control valve ensures simultaneously that an intake force is exerted on the medium in the recirculation circuit. Unused fuel from the fuel cell unit, and fresh fuel fed from the storage tank to the recirculation circuit can thereby be aspired simultaneously. known in principle and does not require further explanation. Further details of the fuel cell system, as for instance an oxygen supply, compressor etc., are not shown, but are nevertheless also familiar to the expert.

Hydrogen and oxygen react in the fuel cell unit 20 catalytically with one another at the electrodes (preferably separated by the polymer electrolyte membrane), so that the fuel cell unit 20 can supply electrical energy. Unused hydrogen and reaction products, (in particular water) reach the output 24 on the anode side as fuel cell waste gas, or correspondingly unused oxygen (possibly nitrogen when using air as oxygen source) and reaction products reach the output 28 on the cathode side of the fuel cell unit 20.

A recirculation circuit 30, which is connected to the output 24 on the anode side of the fuel cell unit 20, returns waste gas from the fuel cell unit 20 on the anode side to the input 22 on the anode side. The recirculation circuit 30 is connected to an intake line 46 of an ejector unit 44a, which is integrated in the valve 44. In the simplest case, the valve 44 can be formed as a T-piece, with one of the three ends formed by the ejector unit 44a. The valve 44 can also be a so-called jet pump, in which the ejector unit 44a is the input of the material flow to be accelerated or recirculated. A component with the known Coanda effect is also conceivable. The term Coanda effect refers to different phenomena which suggest a tendency of gas or fluid flow to “flow along” a convex surface instead of separating and move further in the original flow direction. The ejector unit 44a would here also be the input to the material flow to be accelerated or recirculated. A control valve can precede the valve 44; or the valve 44 can contain such a valve.

A separate branch line 54 leads from a branch 14 away from the feed line 52, and is connected to the recirculation circuit 30. A control valve 48 arranged in the branch line 54, adjusts the fuel amount to be fed. The branch line 54 leads to an input point 16 in the recirculation circuit 30, so that fresh fuel from the storage tank 50 can be fed to the recirculation circuit 30. One or more additional valves (not shown) can be arranged in the fuel feed lines 52 and/or 54, to limit the pressure in the fuel circuit.

A water precipitator 40 and a conveyor unit 42 (preferably a fan) for the unused fuel from the fuel cell system 20 are arranged successively in the recirculation circuit 30 in the flow direction 34 of the fuel cell waste gas. The water precipitator removes liquid water from the fuel cell waste gas, which can for example be fed to a humidifier for the fuel and/or the oxidation means on the cathode side. The input point 16 for fresh fuel from the storage tank 50 is provided between the conveyor unit 42 and the ejector unit 44a.

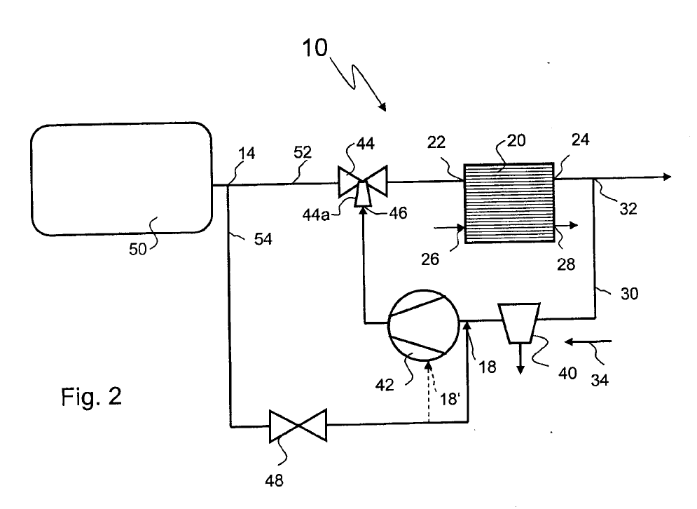

FIG. 2 shows alternative or additional connection possibilities. An input point 18 for fresh fuel from the storage tank 50 can be provided upstream of the conveyor unit 42.

It is indicated with a broken line that an input point 18′ for fuel from the storage tank 50 at the conveyor unit 42 can also be provided in such a manner that the fuel can be used to support the drive of the conveyor unit 42. This is particularly advantageous if the conveyor unit 42 is formed as a fan and the input point 18′ guides/directs the fuel flow to the propeller of the fan in such a manner that an additional pulse is transferred to the propeller by the fuel, so as to drive the propeller. The necessary (preferably electrical) drive power of the engine is thereby reduced. Alternatively, the input point 18′ can also be provided at other locations which are susceptible to humidity or water and ice formation (e.g., at a bearing position of the fan which is otherwise subjected to humidity). Other locations would be a shaft or another movable part with low distances/slot measurements to unmovable parts, where water or humidity can accumulate. A condensation/accumulation of water in the fan or in parts thereof can thereby be avoided or at least be reduced significantly.

A control unit (not shown) is provided for controlling the amount of added fuel via the feed lines 52 and 54. In this manner, it is ensured that the amount of added fuel always corresponds to the desired stoichiometry, so that a deficiency or an excess of fuel is avoided. The fuel amount flowing through valve 48 can thereby be increased deliberately over the normal amount, as for example with high dynamic load requirements, or during start-up.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-14. (canceled)

15. A fuel circuit of a fuel cell system having a fuel cell unit with an input on an anode side for feeding fuel from a storage tank to the fuel cell unit, and an output on the anode side for discharging fuel cell waste gas on the anode side from the fuel cell unit; said fuel circuit comprising:
a recirculation circuit, by means of which fuel cell waste gas from the output on the anode side can be returned to the input on the anode side; wherein
the recirculation circuit is connected to an intake line of an ejector unit; and
fuel from the storage tank can be fed directly into the recirculation circuit.

16. The fuel circuit according to claim 15, further comprising a water precipitator and a hydrogen conveyor unit which are arranged in the recirculation circuit, successively in the flow direction of the fuel cell exhaust gas.

17. The fuel circuit according to claim 15, wherein an input point for fuel from the storage tank is provided between the hydrogen conveyor unit and the ejector unit.

18. The fuel circuit according to claim 16, wherein an input point for fuel from the storage tank is provided upstream the hydrogen conveyor unit.

19. The fuel circuit according to claim 16, wherein an input point for fuel from the storage tank is provided at the hydrogen conveyor unit, such that the fuel can be used for supporting the drive of the hydrogen conveyor unit.

20. The fuel circuit according to claim 19, wherein:
the hydrogen conveyor unit comprises a fan; and
the input point is provided at a bearing location of the hydrogen conveyor unit.

21. The fuel circuit according to claim 19, wherein:
the hydrogen conveyor unit comprises a fan; and
the input point for fuel from the storage tank is provided at a location susceptible to humidity, water or ice formation.

22. The fuel circuit according to claim 15, wherein the ejector unit is integrated in a control valve for controlling the fuel feed to the fuel cell unit.

23. The fuel circuit according to claim 15, wherein a valve is arranged between the storage tank and the recirculation circuit.

24. The fuel circuit according to claim 23, wherein the valve comprises one of a control valve, a gas flow limiting valve, a throttle valve, and a valve in clock form.

25. The fuel circuit according to claim 23, wherein the valve controls the amount of fuel which flows between the storage tank and the recirculation circuit.

26. The fuel circuit according to claim 15, wherein at least one additional valve for limiting the fuel pressure in the fuel circuit is arranged between the storage tank and the recirculation circuit or between the storage tank and the valve.

27. The fuel circuit according to claim 15, wherein fuel amounts flowing through the valve and the valve are controlled by a control unit.

28. The fuel circuit according to claim 26, wherein the fuel amount flowing through the valve is variable in dependence on the load requirement to the fuel cell or the operating state of the fuel cell.
